(19) United States
(12) Patent Application Publication
(10) Pub. No.: US 2003/0230833 A1
(43) Pub. Date: Dec. 18, 2003

(54) Method of producing polyester filaments by heat drawing with hot tubes

(75) Inventors: Yang Bo, Shanghai (CN); Chen Ke Quan, Shanghai (CN); Xu Xiao Chen, Shanghai (CN); Ji Sun Jie, Shanghai (CN); Zhang Wei Dong, Shanghai (CN); Zeng Hai Ying, Shanghai (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sinopec Shangai Petrochemical Company Limited, Shanghai (CN)

(21) Appl. No.: 10/453,775

(22) Filed: Jun. 2, 2003

(30) Foreign Application Priority Data
Jun. 13, 2002 (CN) 02112053.6

(51) Int. Cl. B29C 47/60

(52) U.S. Cl. 264/486; 264/211.22

(57) ABSTRACT

A method of producing polyester filaments by heat drawing with hot tubes comprising shaping by lateral blowing of air the polyester melt extruded through the spinneret; passing the cooled as-spun fibers into hot tubes and heat drawing them; obtaining polyester filaments after the procedures of bundling, oiling, entangling, winding and the like, wherein the hot tube temperature is 80-200° C. and the winding speed is 2500-5300 m/min. The heated hot tube for drawing consists of an internal tube assembly and an electromagnetic induction heating element. The latter is a coil of high temperature resistant metal wire wound on the external wall of the internal tube. In the coil a current is passed, which is controlled by a temperature control circuit of a single return circuit. The key feature of the invention lies in the use of electromagnetic induction heating instead of the traditional heating by diphenyl vapor, being advantageous in that there is no need of heat transfer medium, no leakage of diphenyl, and the hot tube temperature is easier to control, resulting in a greater possibility for development of the kinds of products.

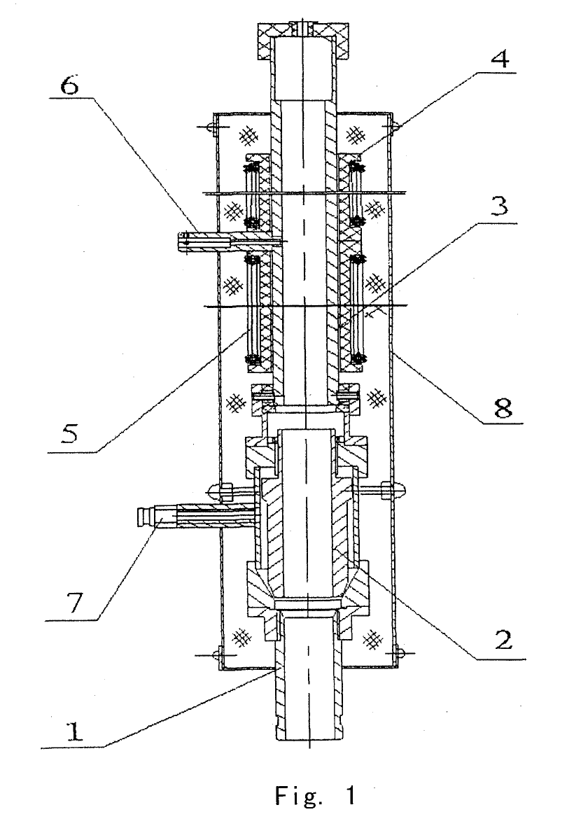

### FIELD OF THE INVENTION

The present invention relates to a method of producing polyester filaments by heat drawing with hot tubes heated by electromagnetic induction.

### BACKGROUND ART

The hot tube spinning technique is a new spinning technique first developed by Barmarg A G. Germany at the beginning of nineteen nineties, it is particularly suited for producing fine denier polyester filaments. Different from the heated roller method, the second pass drawing of raw yarn is performed within a set of hot tubes, this method is advantageous in that the yarns are heated very uniformly in the heating region. The prior art heating of hot tubes employs a jacket containing diphenyl vapor. Usually the diphenyl in a diphenyl tank is heated to vaporize by electric heating bars, and then the diphenyl vapor formed passes through the jacket of hot tubes to heat them. The hot tubes heated in this manner can substantially satisfy the requirements of hot tube spinning technique, but such a way of heating the hot tubes has the following drawbacks: 1) The heat transfer path of the heating medium, diphenyl vapor, is long and thus the resistance to heat transfer is high, resulting in low efficiency of heat transfer and, therefore, increased heating time of hot tubes, and, moreover, the response and adjustment capability toward disturbances are inferior; 2) a certain degree of vacuum is needed in the jacket containing diphenyl vapor to assure the heating temperature of hot tubes, and for this reason the diphenyl gas at a high temperature must be discharged before adjustment and maintenance, which is harmful to human body; 3) liquid diphenyl is condensed in diphenyl tank before it is vaporized, and the liquid diphenyl is still not flowable even it is heated. From the view of controlling the spinning technology, the hot tube temperature under the vaporization of diphenyl (at 93° C.) is not controllable, and, therefore, this temperature interval is a dead zone, limiting the development of technology.

### DISCLOSURE OF THE INVENTION

The technical problems to be solved by this invention is to provide a method of producing polyester filaments by heat drawing with hot tubes, wherein the hot tubes for heat drawing are heated by electromagnetic induction, so as to eliminate the drawbacks associated with the heating of diphenyl.

The technical scheme solving the technique problems described above by the present invention is as follows:

A method of producing polyester filaments by heat drawing with hot tubes comprising shaping by lateral blowing of air the polyester melt extruded through the spinneret; passing the cooled as-spun fibers into hot tubes and heat drawing them; obtaining polyester filaments after the procedures of bundling, oiling, entangling, winding and the like, wherein the hot tube temperature is 80-200° C. and the winding speed is 2500-5300 m/min. The method is characterized in that a hot tube for heat drawing consists of an internal tube assembly and an electromagnetic induction heating element. The electromagnetic induction heating element is a coil of high temperature resistant metallic wire wound on the external wall of the internal tube, and in the coil is passed a current controlled by a single loop temperature controlling circuit. On the wall of the internal tube there is attached a temperature sensor, the temperature signal of which is fed back to the single loop temperature controlling circuit. The number of turns of the coil is determined by the following empirical equation:

$$N = \sqrt{\frac{1600 η l}{DP \sqrt{ρμ f}}} U Cos Φ$$

in which: η is efficiency; 1 is the effective heating length required in cm; cosΦ is power factor; D is coil diameter in cm; U is the resistivity of internal tube material; μ is relative magnetic permeability of internal tube material; f is working frequency; ∪ is voltage; P is the heating power of one hot tube determined by spinning technology in kw.

The cross-sectional area Sc of the conductor wire used for the coil is determined by the following formula:

Sc=I/j

wherein I is working current and j is current density.

Usually the coil is not wound directly on the wall of the internal tube but on a cylindrical former over the external wall of the internal tube, which is made of high temperature resistant insulating material. The high temperature resistant insulating material is selected from polytetrafluoroethylene, organosilicon, fictile mica or the like.

Usually the length of internal tube is 0.8-3.5 m, its inner diameter is 20-85 mm, and its wall thickness is 2-10 mm. The internal tube assembly is usually made of carbon steel. The coil wire must be resistant to high temperature, preferably high temperature enameled copper wire on account of its good performance, low price and the like.

In order to reduce heat loss, the outside surface of hot tubes must be covered with a thermal insulation material such as glass fibre, asbestos, aluminum silicate and the like, or the hot tubes are disposed in a stainless steel housing with the above thermal insulation material filled between the housing and hot tubes, and the stainless steel housing serves to prevent electromagnetic leakage at the same time.

The key feature of the present invention lies in the principle of the use of electromagnetic induction to generate induction eddy current in a conductor and thus generate joule heat for heating the conductor itself and the ingenious utilisation of the skin effect on the tubular structure of hot tubes, resulting in the use of electromagnetic induction heating instead of the conventional diphenyl vapor heating. As compared to prior art, the advantage of the present invention is no necessity of heat transfer medium and thus without the danger of leakage of the harmful gas diphenyl. Because the heat of hot tubes comes from the tube wall material itself, the heating time is short and the electrothermal transformation efficiency is high. Further, since electromagnetic induction heating is easier to adjust than heating by diphenyl, not only the control of spinning process is facilitated, but the individual temperature control of a particular hot tube is made easier to achieve, resulting in a greater possibility of the development of various kinds of differential fibres.

### DESCRIPTION OF DRAWINGS

The figure shows schematically the cross-sectional structure of an embodiment of a hot tube used for heat drawing in the method of producing polyester filament according to the present invention.

It can be seen from the figure that an internal tube assembly is composed by successive connection of an internal tube 3, an adjustment tube 2 and an adapter 1. The external wall of the internal tube 3 is cased with a cylindrical former 4 made of fictile mica, and a coil 5 of high temperature resistant enameled copper wire is wound on the former 4. In the coil there is passed a current controlled by a single loop temperature control circuit. On the wall of the internal tube a platinum resistance temperature sensor 6 is attached, the temperature signal of which is fed back to the single loop temperature control circuit. A compressed air inlet 7 is provided, the compressed air being used to guide the filament during the process of spinning. The hot tube is placed in a stainless steel housing with glass fibre filled between the housing and the hot tube.

### EXAMPLES

In the following examples the following main parameters are used:

Material of hot tube assembly: carbon steel (ρ=38/300° C., μ=250)

Length of hot tube: 1.5 m

Effective heating length of hot tube: 1 m

Wall thickness of hot tube: 3 mm

Inner diameter of hot tube: 34 mm

Heating power of hot tube: 1 kw

Number of turns of coil: 1060

Conductor wire of coil: polyaminoimine enameled copper wire (diameter 2.24 mm)

Current: 6.5 A

Voltage: 220 V

Frequency: 50 Hz

### TECHNOLOGICAL APPLICATION TESTS OF HEAT TUBES

Examples 1-4

Melt of polyester was extruded through spinneret with the temperature of spinning head being 285-295° C. and shaped by lateral blowing of air. Then the cooled as-spun fibres were passed into hot tubes and heat drawn, and thereafter were bundled, oiled, entangled and wound to give FDY. The specifications of the products 15 and concrete spinning technology are listed in Table 1. The properties of products are given in Table 2.

TABLE 1

| | Specification of | Temperature of hot | |
|---|---|---|---|
| | product | tube | Winding speed |
| | (dtex/f) | (° C.) | (m/min) |
| Example 1 | 55/72 | 80 | 2500 |
| Example 2 | 55/36 | 85 | 2500 |
| Example 3 | 83/36 | 80 | 3200 |
| Example 4 | 111/36 | 85 | 3300 |
| Example 5 | 111/36 | 160 | 4200 |
| Example 6 | 55/36 | 170 | 4200 |
| Example 7 | 83/36 | 170 | 4200 |
| Example 8 | 111/36 | 170 | 4200 |
| Example 9 | 83/36 | 180 | 5000 |
| Example 10 | 111/36 | 200 | 5300 |

TABLE 2

| | | | | Boiling water |
|---|---|---|---|---|
| | Titre | Strength | Elongation | Shrinkage |
| | (dtex) | (cN/dtex) | (%) | (%) |
| Example 1 | 55.1 | 2.45 | 98.23 | 46.8 |
| Example 2 | 55.2 | 2.23 | 102.67 | 45.5 |
| Example 3 | 83.3 | 2.47 | 112.42 | 54.6 |
| Example 4 | 110.8 | 2.62 | 118.53 | 53.8 |
| Example 5 | 110.9 | 3.89 | 37.34 | 6.98 |
| Example 6 | 54.9 | 3.91 | 32.25 | 5.90 |
| Example 7 | 82.9 | 3.84 | 35.99 | 6.33 |
| Example 8 | 111.4 | 3.91 | 36.98 | 6.27 |
| Example 9 | 83.3 | 4.21 | 33.01 | 5.67 |
| Example 10 | 111.5 | 4.22 | 33.18 | 5.22 |

1. A method of producing polyester filaments by heat drawing with hot tubes comprising shaping by lateral blowing of air the polyester melt extruded through the spinneret; passing the cooled as-spun fibers into hot tubes and heat drawing them; obtaining polyester filaments after the procedures of bundling, oiling, entangling, winding and the like, wherein the hot tube temperature is 8-200° C. and the winding speed is 2500-5300 m/min; the method being characterized in that a hot tube for heat drawing consists of an internal tube assembly and an electromagnetic induction heating element;The electromagnetic induction heating element is a coil of high temperature resistant metallic wire wound on the external wall of the internal tube, and in the coil is passed a current controlled by single loop temperature controlling circuit ; on the wall of the internal tube there is attached a temperature sensor, the temperature signal of which is fed back to the single loop temperature controlling circuit , the number of turns of the coil is determined by the following empirical equation:
$$N = \sqrt{\frac{1600 η l}{DP \sqrt{ρμ f}}} U Cos Φ$$
in which: η is efficiency; 1 is the effective heating length required in cm; cosΦ is power factor; D is coil diameter in cm; p is the resistivity of internal tube material; μ is relative magnetic permeability; f is working frequency; U is voltage; P is the heating power of one hot tube determined by spinning technology in kw.

2. Method of producing polyester filaments as described in claim 1, characterized in that the cross-sectional area of the conductor wire of the coil in the heated hot tube for drawing is determined by the following formula:
Sc=I/j
wherein I is working current and j is current density.

3. Method of producing polyester filaments as described in claim 1 or 2, characterized in that there is a cylindrical former over the external wall of the internal tube in said heated hot tube for drawing, the former is made of a high temperature resistant insulating material, and the coil is wound on the cylindrical former.

4. Method of producing polyester filaments as described in claim 1 or 2, characterized in that the length of the internal tube in said heated hot tube for drawing is 0.8-3.5 m, its inner diameter is 20-85 mm, and its wall thickness is 2-10 mm.

5. Method of producing polyester filaments as described in claim 1 or 2, characterized in that the internal tube assembly in said heated hot tube for drawing is made of carbon steel, and the high temperature resistant metallic wire is the high temperature resistant enameled copper wire.

6. Method of producing polyester filaments as described in claim 3, characterized in that the cylindrical former in the said heated hot tube for drawing is made of polytetrafluoroethylene, organosilicon, fictile mica or the like.
